(19) United States
(12) Patent Application Publication
(10) Pub. No.: US 2013/0191272 A1
(43) Pub. Date: Jul. 25, 2013

(54) Systems and Methods for Division and Identification of Financial Transfers

(71) Applicant: The Western Union Company, Englewood, CO (US)

(72) Inventors: Chris Cochran, Highlands Ranch, CO (US); Rodrigo Sada, Lone Tree, CO (US)

(73) Assignee: The Western Union Company, Englewood, CO (US)

(21) Appl. No.: 13/711,233

(22) Filed: Dec. 11, 2012

Related U.S. Application Data
(60) Provisional application No. 61/589,174, filed on Jan. 20, 2012.

(51) Int. Cl. G06Q 20/10

(52) U.S. Cl. CPC G06Q 20/10
USPC 705/39

(57) ABSTRACT

According to the invention, a system for dividing and identifying financial transfers is disclosed. The system may include a server configured to receive an indication that an amount of funds has been received. The server may also be configured to associate, in response, a first identifier with the amount of funds. The server may further be configured to receive a first request to release a first portion of the funds, the first request including the first identifier. The server may additionally be configured to associate a first record of release with the first identifier. The server may moreover be configured to associate, in response to receiving the first request, a second identifier with a second portion of the funds. The server may furthermore be configured to receive a second request to release at least a portion of the second portion of the funds, the second request including the second identifier.

### CROSS-REFERENCE TO RELATED APPLICATIONS

This application claims priority to Provisional U.S. Patent Application No. 61/589,174 filed Jan. 20, 2012, entitled “SYSTEMS AND METHODS FOR CONDUCTING SPLIT MONEY PAYOUT OF MONEY TRANSFERS,” the entire disclosure of which is hereby incorporated by reference, for all purposes, as if fully set forth herein.

### BACKGROUND OF THE INVENTION

The various embodiments of the invention discussed herein relate generally to financial transfers. More specifically, the various embodiments of the invention discussed herein relate at least to methods of routing funds from a single money transfer into at least two different financial transactions, and determining how to coordinate and identify such resultant transactions.

### BRIEF DESCRIPTION OF THE INVENTION

In one embodiment, a system for dividing and identifying financial transfers is provided. The system may include a server. The server may be configured to receive an indication that an amount of funds has been received. The server may also be configured to associate, in a storage medium, in response to receiving the indication, a first identifier with the amount of funds. The server may further be configured to receive a first request to release a first portion of the funds, the first request including the first identifier. This first release of funds may be made in any possible form, including cash, credit, debit, pre-paid card, money transfer from another source, wire-transfer, other electronic method, etc. The server may additionally be configured to associate, in the storage medium, a first record of release with the first identifier. The server may moreover be configured to associate, in the storage medium, in response to receiving the first request, a second identifier with a second portion of the funds. The server may furthermore be configured to receive a second request to release at least a portion of the second portion of the funds, the second request including the second identifier. This second release of funds may be made in any possible form, including cash, credit, debit, pre-paid card, money transfer from another source, wire-transfer, other electronic method, etc.

In another embodiment, a method for dividing and identifying financial transfers is provided. The method may include receiving an indication that an amount of funds has been received. The method may also include associating, in a storage medium, in response to receiving the indication, a first identifier with the amount of funds. The method may further include receiving a first request to release a first portion of the funds, the first request including the first identifier and an identification of a manner in which the first portion of the funds are released. The method may additionally include associating, in the storage medium, a record of release with the first identifier. The method may moreover include determining, based on the identification, to associate, in the storage medium, a second identifier with a second portion of the funds. The method may furthermore include associating in the storage medium, a second identifier with a second portion of the funds. The method may also include receiving a second request to release at least a portion of the second portion of the funds, the second request including the second identifier.

In another embodiment, a non-transitory machine-readable storage medium having instructions thereon for dividing and identifying financial transfers is provided. A processor or processors, such as a centralized server or servers operated by a money transfer service, may be operable to execute these instructions. The instructions may be executable by a processor to receive an indication that an amount of funds has been received. The instructions may also be executable by the processor to associate, in response to receiving the indication, a first identifier with the amount of funds (“loading” the funds). The instructions may further be executable by the processor to receive a first request to release a first portion of the funds, the first request including the first identifier and an identification of a manner in which the first portion of funds are released. The instructions may additionally be executable by the processor to determine, based on the identification, whether to associate, in the storage medium, a second identifier with a second portion of the funds. The instructions may moreover be executable by the processor to, in response to a negative determination, associate a first record of release with the first identifier; and in response to a positive determination, associate a second identifier with a second portion of the funds, and associate a second record of release with the first identifier. The instructions may additionally be executable by the processor to receive a second request to release at least a portion of the second portion of the funds. The second request may include the first identifier if the determination was negative or the second identifier if the determination was positive.

### BRIEF DESCRIPTION OF THE DRAWINGS

The present invention is described in conjunction with the appended figures:

FIG. 1 is a block diagram of a system embodiment of the invention for dividing and identifying financial transfers;

FIGS. 2A and 2B are block diagrams of a method embodiment of the invention for dividing and identifying financial transfers; and

FIG. 3 is a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. A person of skill in the art will understand after reading the disclosure that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a method or process which is depicted as a flowchart, a flow diagram, a data flow diagram, a structure diagram, or a block diagram. Although a flowchart or the discussion herein may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. Additionally, any particular component of one system or method embodiment may or may not be present in that or any other possible system or method embodiment, depending on the specific embodiment. A process may correspond to a method, a function, a procedure, a subroutine, a subprogram, etc. When a process corresponds to a function, its termination corresponds to a return of the function to the calling function or the main function.

The term “machine-readable medium” includes, but is not limited to transitory or non-transitory mediums, portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

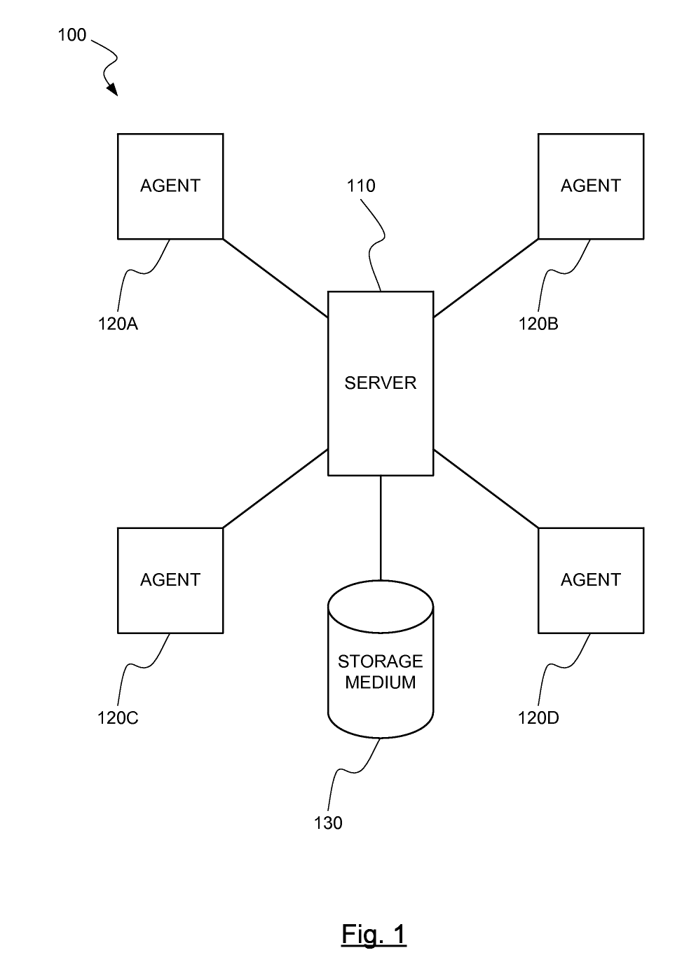

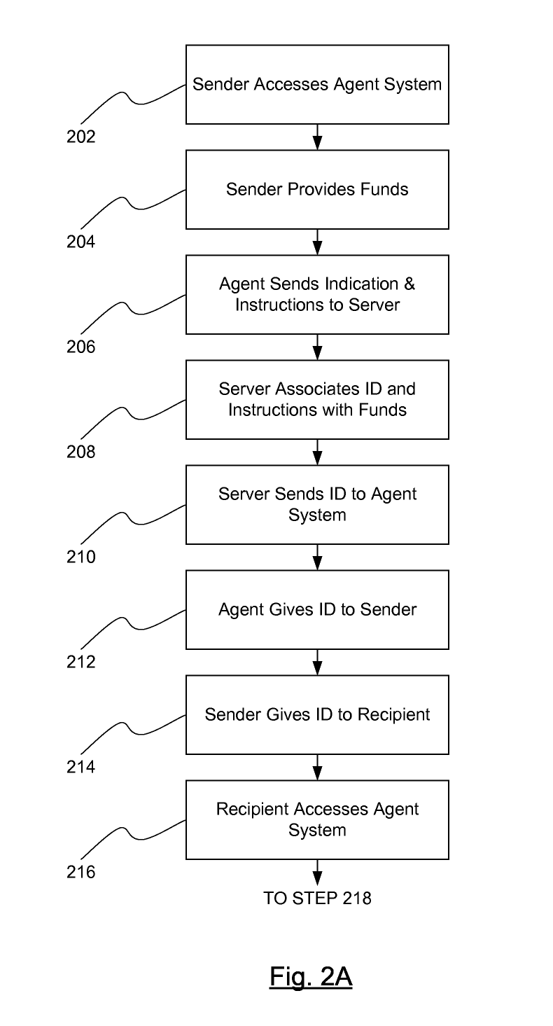

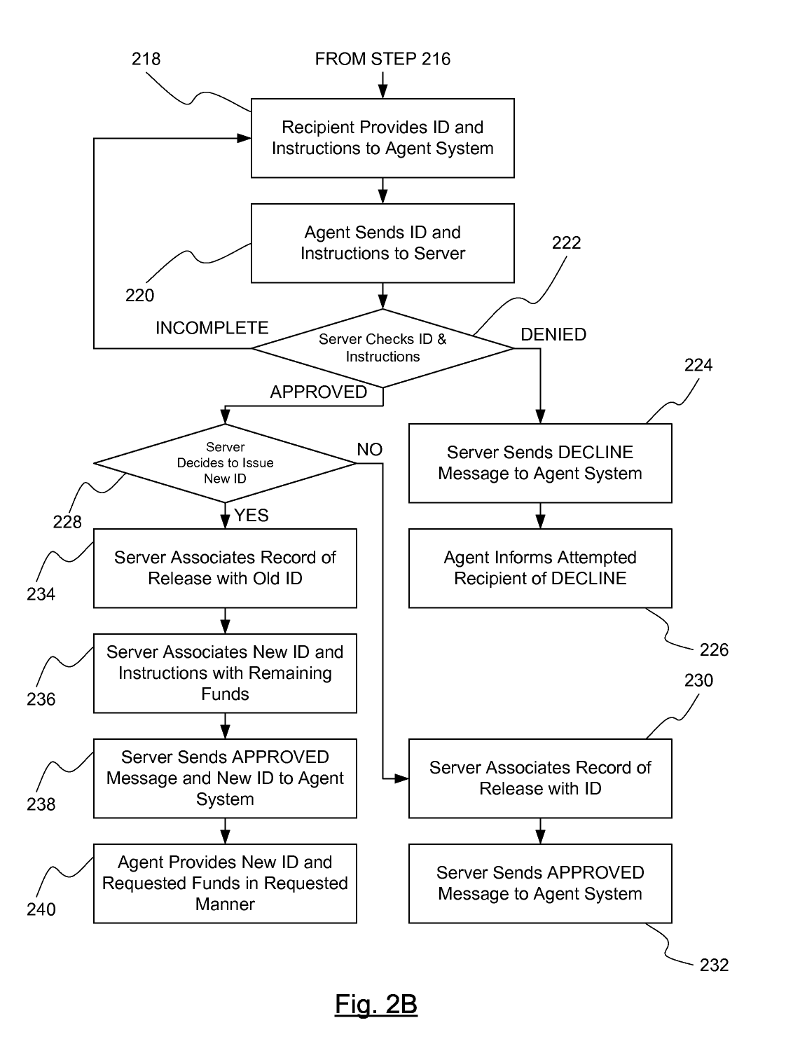

In one embodiment of the invention, a system and method for dividing and identifying financial transfers is provided. The system and method will be discussed with references to FIG. 1 and FIGS. 2A & 2B.

The system 100 may include a server 110 in communication with a plurality of agent systems 120 or locations. A sender may access an agent system 120 (STEP 202) and provide funds (STEP 204) thereto. In some embodiments, agent system 120 may be an online interface, possibly provided via a web browser of an agent operator or the sender themselves. The funds may be received in any number of manners, including cash, credit, debit, pre-paid card, money transfer from another source, wire-transfer, etc.

The sender may also provide instructions regarding receipt of the money transfer by an intended recipient, and these instructions may also be transmitted to server 110. For example, the sender may dictate when, where, and how the intended recipient may take delivery of funds. How a recipient may take delivery of funds may include restrictions on the manner in which the funds are received. For example, the restrictions may limit the mechanism used to receive the funds to one or more of a cash payout, a pre-paid financial instrument or card, a payment to an e-wallet, a diversion to a new money transfer by the recipient, a bill payment, a diversion to a new wire-transfer by the recipient, or an Automated Clearing House (“ACH”) transfer.

Agent system 120 may be configured to transmit an indication that funds and instructions have been received to server 110 (STEP 206). Server 110 may also be configured to associate, in a storage medium 130, in response to receiving the indication, a first identifier (“ID”) with the amount of funds (STEP 208). Merely by way of example, the first ID may be a money transfer control number (“MTCN”). The ID may uniquely identify to server 110 that the funds are available for transfer to a recipient. Any further instructions from the sender may also be associated by server 110 with the funds and the first ID (STEP 208).

Server 110 may transfer the ID back to agent system 120 (STEP 210). The ID may be further communicated to the sender by agent system 120 (STEP 212). The sender may then provide this ID to a recipient they intend for the money transfer (STEP 214). In some embodiments, the agent system may be configured to e-mail or otherwise automatically provide the ID to the recipient per instructions and delivery information provided by the sender.

The recipient may then visit or otherwise access an agent system 120 as similarly done by the sender, but perhaps at another location (STEP 216). The recipient may request, via agent system 120, release of all or a first portion of the funds previously submitted by the sender. In order to do so the recipient may provide the ID to the agent system (STEP 218). The recipient may also provide instructions on what manner/mechanism they would like to receive the funds through (STEP 218). Agent system 120 may transmit the ID, amount requested, and instructions to server 110 as a request to release the funds (STEP 220). This “request to release” funds may, in some embodiments, be a checking by agent system 120 of information at server 110 to determine if the release should occur. Thus, in some embodiments, agent system 120 may make the actual determination of whether or not to release funds based on information obtained from communication with server 110. In these embodiments, the “request to release,” or a second portion of such request after actual release, may further serve to inform server 110 that the funds associated with a particular ID have been dispersed.

The server may be configured to determine whether the ID is properly associated with funds in the storage medium (STEP 222). Other verifying information may be provided to the server from the recipient via the agent, including for example personal identification, social security numbers, birth dates, phone numbers, addresses or other information, in order to properly verify to the server that the recipient is authorized to receive the funds. The proposed instructions from the recipient for the manner/mechanism of delivery of the funds are also checked against the acceptable possible directions provided by the sender (STEP 222).

If the ID, recipient, and manner for delivery are not consistent with information stored in association with the first ID, a decline message is sent from server 110 to agent system 120 (STEP 224). The agent or agent system then informs the attempted recipient of the declination (STEP 226). If an incorrect or incomplete ID was originally provided, or improper or incomplete instructions per the terms set by the sender, this information may be relayed to the recipient. The recipient may then restart the process (STEP 218).

If the ID, recipient, and manner for delivery are consistent with information stored in association with the first ID, server 110 decides whether a new ID should be issued (STEP 228). If all of the funds have been requested for release, then no new ID may be issued because there will be no remaining funds after the transfer. In this case the server associated a record of release with the old ID (block 230). The record of release is either a notation that all of the funds have been dispensed to the recipient, or a zeroing of the funds associated with the old ID.

In the alternative, if the recipient is requesting less than the entire amount of funds associated with the ID, server 110 may check a stored list of manners/mechanisms/means in which distribution of a partial amount of the funds necessitates a new ID being associated with the remaining funds after distribution. Merely by way of example, this list may include one or more of a cash payout, a pre-paid financial instrument or card, a payment to an e-wallet, a diversion to a new money transfer by the recipient, a bill payment, a diversion to a new wire-transfer by the recipient, and/or an Automated Clearing House (“ACH”) transfer. In some embodiments, any request for release will be required to direct action for 100% of the funds. This may be accomplished either by requiring explicit instructions for all sub-portions of the funds, or by automatically implying that any unrequested funds remain associated with the old ID.

If the manner in which the funds are requested is not on the list, then the server will associate a record of release with the ID as discussed before (STEP 230), and send an approved message to agent system 120 (STEP 232). The difference in this transaction from before is that the record of release will either indicate the portion distributed from the funds, the amount remaining of the funds, and/or a new balance of the funds.

If the manner in which the funds are requested is on the list, then a new ID for the remaining portion of funds will be necessary. Server 110 then associates an appropriate record of release with the old ID (STEP 234), and associates a new ID with the remaining funds (STEP 236). The new ID may also be stored in the record of release associated with the old ID in order to provide for later tracking of the funds. Finally, server 110 sends an approval message to agent system 120 (STEP 238) and the requested funds are distributed according to the requested manner (STEP 240).

The process may then be repeated by an intended recipient with all or a portion of the remaining funds associated with the new ID. The process may repeat as many times as the recipient would like so long as funds are still available in the system. Additionally, a sender or senders may submit additional funds to associate with a particular ID. As an example, a recipient may request a pre-paid card or other instrument for each withdrawal, and the remaining funds may be associated with a new ID, to be withdrawn in cash, partially or wholly. A new ID may assist the server in tracking remaining funds, or provide the security of a new ID every time a split payout occurs in such a manner.

In another embodiment of the invention, a method for dividing and identifying financial transfers is provided. The method may include receiving an indication that an amount of funds has been received. The method may also include associating, in a storage medium, in response to receiving the indication, a first identifier with the amount of funds. The method may further include receiving a first request to release a first portion of the funds, the first request including the first identifier and an identification of a manner in which the first portion of the funds are released. The method may additionally include associating, in the storage medium, a record of release with the first identifier. The method may moreover include determining, based on the identification, to associate, in the storage medium, a second identifier with a second portion of the funds. The method may furthermore include associating in the storage medium, a second identifier with a second portion of the funds. The method may also include receiving a second request to release at least a portion of the second portion of the funds, the second request including the second identifier.

In another embodiment of the invention, a non-transitory machine-readable storage medium having instructions thereon for dividing and identifying financial transfers is provided. The instructions may be executable by a processor to receive an indication that an amount of funds has been received. The instructions may also be executable by the processor to associate, in response to receiving the indication, a first identifier with the amount of funds. The instructions may further be executable by the processor to receive a first request to release a first portion of the funds, the first request including the first identifier and an identification of a manner in which the first portion of funds are released. The instructions may additionally be executable by the processor to determine, based on the identification, whether to associate, in the storage medium, a second identifier with a second portion of the funds. The instructions may moreover be executable by the processor to, in response to a negative determination, associate a first record of release with the first identifier; and in response to a positive determination, associate a second identifier with a second portion of the funds, and associate a second record of release with the first identifier. The instructions may additionally be executable by the processor to receive a second request to release at least a portion of the second portion of the funds. The second request may include the first identifier if the determination was negative or the second identifier if the determination was positive.

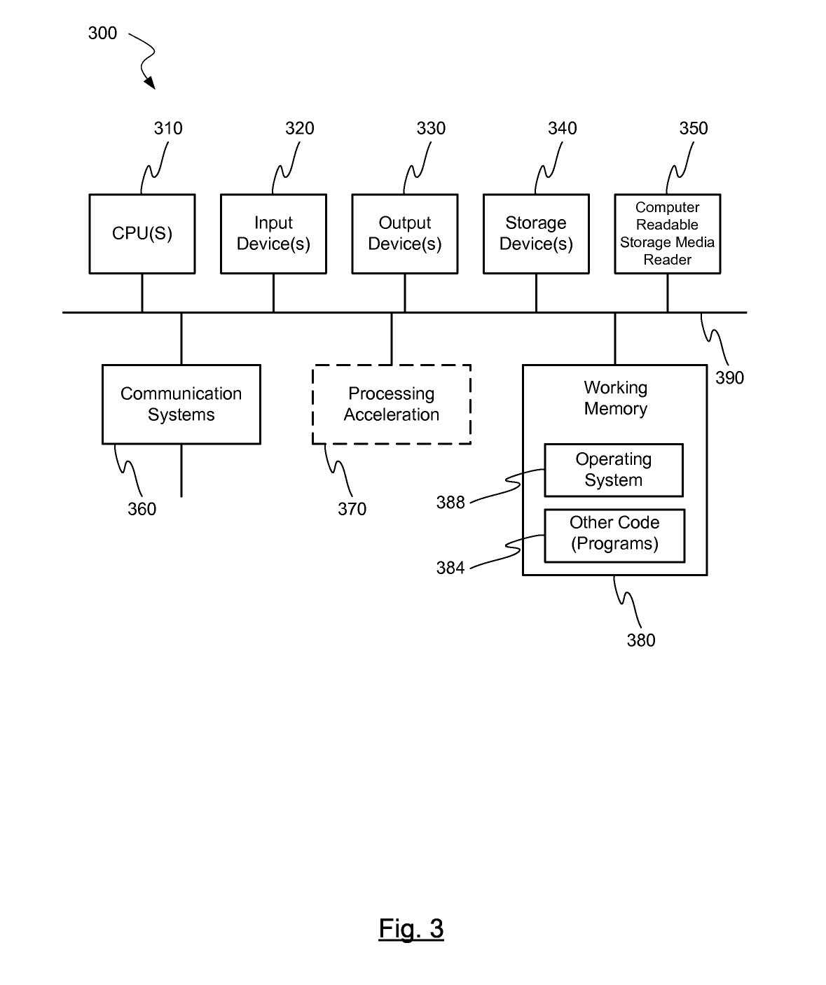

FIG. 3 is a block diagram illustrating an exemplary computer system 300 in which embodiments of the present invention may be implemented. This example illustrates a computer system 300 such as may be used, in whole, in part, or with various modifications, to provide the functions of the servers, the agent systems, the processors, and/or other components of the invention such as those discussed above. For example, various functions of the server may be controlled by the computer system 300, including, merely by way of example, storing and associating identifiers, records of release and communication of related and necessary information to agent systems, etc.

The computer system 300 is shown comprising hardware elements that may be electrically coupled via a bus 390. The hardware elements may include one or more central processing units 310, one or more input devices 320 (e.g., a mouse, a keyboard, etc.), and one or more output devices 330 (e.g., a display device, a printer, etc.). The computer system 300 may also include one or more storage device 340. By way of example, storage device(s) 340 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 350, a communications system 360 (e.g., a modem, a network card (wireless or wired), an infra-red communication device, Bluetooth™ device, cellular communication device, etc.), and working memory 380, which may include RAM and ROM devices as described above. In some embodiments, the computer system 300 may also include a processing acceleration unit 370, which can include a digital signal processor, a special-purpose processor and/or the like.

The computer-readable storage media reader 350 can further be connected to a computer-readable storage medium, together (and, optionally, in combination with storage device(s) 340) comprehensively representing remote, local, fixed, and/or removable storage devices plus storage media for temporarily and/or more permanently containing computer-readable information. The communications system 360 may permit data to be exchanged with a network, system, computer and/or other component described above.

The computer system 300 may also comprise software elements, shown as being currently located within a working memory 380, including an operating system 384 and/or other code 388. It should be appreciated that alternate embodiments of a computer system 300 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 300 may include code 388 for implementing any or all of the function of the various elements of the architecture as described herein. For example, software, stored on and/or executed by a computer system such as system 300, can provide the functions of the servers, the agent systems, the processors, and/or other components of the invention such as those discussed above. Methods implementable by software on some of these components have been discussed above in more detail.

The invention has now been described in detail for the purposes of clarity and understanding. However, it will be appreciated that certain changes and modifications may be practiced within the scope of the appended claims.

What is claimed is:

1. A system for dividing and identifying financial transfers, wherein the system comprises:
a server configured to:
receive an indication that an amount of funds has been received;
associate, in a storage medium, in response to receiving the indication, a first identifier with the amount of funds;
receive a first request to release a first portion of the funds, the first request including the first identifier;
associate, in the storage medium, a first record of release with the first identifier;
associate, in the storage medium, in response to receiving the first request, a second identifier with a second portion of the funds; and
receive a second request to release at least a portion of the second portion of the funds, the second request including the second identifier.

2. The system for dividing and identifying financial transfers of claim 1, wherein the server is further configured to:
associate, in the storage medium, in response to receiving the third request, a third identifier with a third portion of the funds; and
receive a third request to release at least a portion of the third portion of the funds, the third requests including the third identifier.

3. The system for dividing and identifying financial transfers of claim 1, wherein at least one of the first identifier or the second identifier comprises:
a money transfer control number (“MTCN”).

4. The system for dividing and identifying financial transfers of claim 1, wherein the first request to release the first portion of the funds comprises:
a request to fund a pre-paid financial instrument.

5. The system for dividing and identifying financial transfers of claim 4, wherein the request to fund the pre-paid financial instrument comprises:
a request to fund a new pre-paid financial instrument.

6. The system for dividing and identifying financial transfers of claim 4, wherein the request to fund the pre-paid financial instrument comprises:
a request to fund a previously funded pre-paid financial instrument.

7. The system for dividing and identifying financial transfers of claim 1, wherein the first request to release the first portion of the funds comprises:
a request to fund a pre-paid financial instrument; and
a request to fund a cash payout.

8. The system for dividing and identifying financial transfers of claim 1, wherein:
the first request further includes:
an identification of a manner in which the first portion of the funds are released; and
the server is further configured to:
determine, based on the identification, whether to associate, in the storage medium, the second identifier with the second portion of the funds.

9. The system for dividing and identifying financial transfers of claim 1, wherein server is further configured to:
associate, in the storage medium, a second record of release with the second identifier.

10. The system for dividing and identifying financial transfers of claim 1, wherein the first record of release comprises:
a reduction in the amount of funds associated with the first identifier.

11. The system for dividing and identifying financial transfers of claim 1, wherein the first record of release comprises:
an identification of a manner in which the first portion of funds was released.

12. The system for dividing and identifying financial transfers of claim 11, wherein the identification of a manner in which the first portion of funds was released comprises:
the second identifier.

13. A method for dividing and identifying financial transfers, wherein the method comprises:
receiving an indication that an amount of funds has been received;
associating, in a storage medium, in response to receiving the indication, a first identifier with the amount of funds;
receiving a first request to release a first portion of the funds, the first request including the first identifier and an identification of a manner in which the first portion of the funds are released;
associating, in the storage medium, a record of release with the first identifier;
determining, based on the identification, to associate, in the storage medium, a second identifier with a second portion of the funds;
associating in the storage medium, a second identifier with a second portion of the funds; and
receiving a second request to release at least a portion of the second portion of the funds, the second request including the second identifier.

14. The method for dividing and identifying financial transfers of claim 13, wherein determining, based on the identification, to associate, in the storage medium, a second identifier with the second portion of funds comprises:
comparing the identification to a first set of manners of fund releasing, the first set including one or more manners of fund releasing; and
determining the identification matches one of the manners in the first set.

15. The method for dividing and identifying financial transfers of claim 14, wherein the first set comprises at least one of:
a cash payout;
a pre-paid financial instrument or card;
a payment to an e-wallet;
a new money transfer;
a bill payment;
a wire transfer; or
an Automated Clearing House (“ACH”) transfer.

16. The method for dividing and identifying financial transfers of claim 13, wherein determining, based on the identification, to associate, in the storage medium, a second identifier with the second portion of funds comprises:
comparing the identification to a first set of manners of fund releasing, the first set including one or more manners of fund releasing; and
determining the identification does not match one of the manners in the first set.

17. The method for dividing and identifying financial transfers of claim 16, wherein the first set comprises at least one of:
a cash payout;
a pre-paid financial instrument or card;
a payment to an e-wallet;
a new money transfer;
a bill payment;
a wire transfer; or
an Automated Clearing House (ACH) transfer.

18. The method for dividing and identifying financial transfers of claim 13, wherein:
the manner in which the first portion of the funds are released comprises a pre-paid financial instrument; and
a manner in which the second portion of the funds are released comprises a cash payout.

19. A non-transitory machine-readable storage medium having instructions thereon for dividing and identifying financial transfers, wherein the instructions are executable by a processor to:
receive an indication that an amount of funds has been received;
associate, in response to receiving the indication, a first identifier with the amount of funds;
receive a first request to release a first portion of the funds, the first request including the first identifier and an identification of a manner in which the first portion of funds are released;
determine, based on the identification, whether to associate, in the storage medium, a second identifier with a second portion of the funds;
in response to a negative determination:
associate a first record of release with the first identifier;
in response to a positive determination:
associate a second identifier with a second portion of the funds; and
associate a second record of release with the first identifier;
receive a second request to release at least a portion of the second portion of the funds, the second request including:
the first identifier if the determination was negative; or
the second identifier if the determination was positive.

20. The non-transitory machine-readable storage medium having instructions thereon for dividing and identifying financial transfers of claim 19, wherein the first record of release comprises:
the second identifier.
